(19) United States
(12) Patent Application Publication
(10) Pub. No.: US 2017/0343277 A1
(43) Pub. Date: Nov. 30, 2017

(54) ILLUMINATING TUBES AND DOORS FOR REFRIGERATOR USING THE SAME

(71) Applicant: LEDTECH Electronics Corp., Zhaoqing City (CN)

(72) Inventor: Jianhua Zhu, Zhaqing City (CN)

(21) Appl. No.: 15/607,857

(22) Filed: May 30, 2017

(30) Foreign Application Priority Data
May 30, 2016 (CN) 201620497309.0

(51) Int. Cl. F25D 27/00; F21S 8/00

(52) U.S. Cl. CPC F25D 27/005; F21S 8/00; F25D 2600/04

(57) ABSTRACT

An illuminating tube of a refrigerator comprises an illuminating surface, a mounting surface, and a support, the mounting surface being used to mount the illuminating tube onto a base and the support being disposed in a middle part inside the illuminating tube to support an illuminating chip, an electric circuit being disposed under the support, wherein the illuminating surface is consisted of a first, second and third surfaces having different thicknesses, wherein the first surface is connected with the third surface and the second surface is connected with the third surface. A door for refrigerator comprises a glass panel, a reflection plate and two lateral sides, and further including a pair of the illuminating tubes mounted on the two lateral sides of the door. The illuminating tube and the door for refrigerator using the illuminating tube effectively enhance the uniformity of intensity to no less than 60%.

### TECHNICAL FIELD

The present invention relates to a refrigerator, and in particular, to an illuminating tube used in a door for refrigerator and a door for refrigerator using the same.

### BACKGROUND

Refrigerated Storage of food, such as drinks, is widely existing in supermarkets, malls and convenient stores. The illuminating surfaces of the refrigerators are always located at the doors of the refrigerators. Lights radiate from the door toward the inside of the refrigerator so that people could see the food from outside of the refrigerator. Nevertheless, the intensity of the light is not uniform in conventional low-temperature refrigerator with the middle part brighter and the marginal area darker. This would cause the food in the middle have a higher temperature, due to the stronger intensity of the light, than that of the food in the marginal area. The difference in temperature is unfavorable for food storage.

### SUMMARY

An object of the invention is to provide an illuminating tube with uniform illumination intensity used in a refrigerator, and a refrigerator using the illuminating tube of the present invention.

The illuminating tube of a refrigerator comprises an illuminating surface used to emit light, a mounting surface for mounting the illuminating tube to a base, and a support disposed in a middle part inside the illuminating tube and supporting an illuminating chip, an electric circuit being disposed under the support, wherein the illuminating surface is consisted of a first, second and third surfaces having different thicknesses, wherein the first surface is connected with the third surface and the second surface is connected with the third surface. The three surfaces could emit an uniform light taking advantage of the thickness differences among the surfaces, avoiding the focus of the light in the middle area of the illuminating surface.

A pair of supports are symmetrically distributed in the inner sides of the tube with one of the supports connecting to the first surface and the other to the second surface. By providing a pair of supports, the illuminating chip can be stably mounted on the supports and located in the middle area of the tube. The illuminating chip is disposed such that the periphery of the chip is equally spaced to the corresponding parts of the first and second surfaces. In this way, the light emitting from the illuminating chip could evenly reach the inner sides of the first, second and third surfaces.

Each of the first and second surfaces has an arc-shaped structure with a uniform thickness, while the third surface has a dome-shaped structure with its middle part having an increased thickness than that of terminal parts. The thickness of the third surface is larger than that of either the first or the second surface. The intensity of the light reaching the first and second surfaces is less that that reaching the third surface, therefore the larger thickness of the third surface enables the intensity of the light emitting from the third surface weak than that emitting from the first and second surfaces. Meanwhile, due to the larger thickness in the middle part of the third surface, the intensity of the light emitting from the third surface will be further homogenized, avoiding the circumstance that a higher intensity exists in the middle part.

Further, the third surface has an inner side parallel with the supports, such that the middle part of the surface has a larger thickness than those of the terminal parts to achieve uniform intensity of emitting light from the third surface.

The invention further provides a door for refrigerator having the illuminating tube as described above. The door for refrigerator comprises a glass panel, a reflection plate and two lateral sides. At least a pair of illuminating tube is provided and mounted to each lateral sides of the door. The light of the illuminating tube emits from the illuminating surfaces that are located at the bottom side of the glass panel, with an uniformity of intensity no less than 60%. This overcomes the less uniformity problems existing with conventional refrigerators.

The distance between the illuminating tube and the bottom side of the glass panel ranges from 15 mm to 50 mm, and the distance between the tube and the reflection plate ranges from 60 mm to 100 mm. The glass panel has a thickness of 20 mm and a length of 650 mm such that the space between the illuminating tube and the top side of the glass panel is less than that between the illuminating tube and the reflection plate. In this way, part of the light emitting toward the top side of the glass panel reflects toward partial area of the bottom side of the glass panel and majority part of the light reaches the reflection plate and reflects toward the top side of the glass panel and then toward a larger area of the bottom side of the glass panel.

Further, the supports has a perpendicular plane having an angle of between 20 degree and 70 degree with respect to the horizontal plane. In this way, the light emitting from the third surface covers the middle area of the reflection plate, while the majority part of the light emitting from the first and second surfaces focuses on the lateral sides, terminal sides of the reflection plate and terminal parts of the top side of the glass panel. The angle is so designed that the light could distribute evenly on the glass panel and emit therefrom to achieve a uniformity of intensity no less than 60%.

Compared to the conventional refrigerators, the illuminating tube and the door for refrigerator using the illuminating tube effectively enhance the uniformity of intensity to no less than 60%. This not only improves the visual effect but also ensures the homogenous temperature between the middle area and periphery parts, which is favorable for the storage of food.

### BRIEF DESCRIPTION OF THE DRAWINGS

FIG. 1 is a sectional view of the illuminating tube of the present invention.

FIG. 2 is a top view of the door for refrigerator according to the present invention.

### DETAILED DESCRIPTION

The invention is now described in more detail with reference to the drawings. The drawings are provided for illustrative purpose only without the intention to limiting. Some parts are omitted, amplified or scaled-down for the purpose of better illustration. It is understood that certain parts or structure in common can be omitted from shown and description.

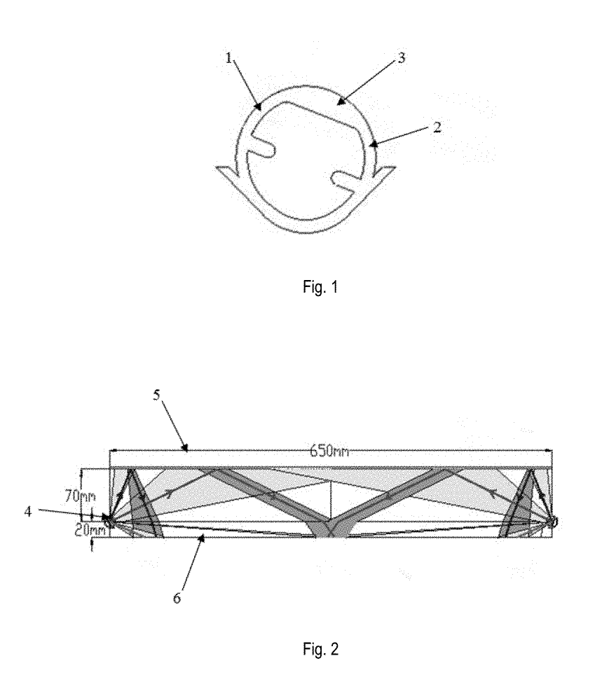

FIG. 1 shows an illuminating tube comprising an illuminating surface, a mounting surface and a support. The illuminating surface emits light for illumination. The mounting surface is used to assemble the tube onto a base and the support is disposed in the middle inside the tube. The illuminating surface is consisted of a first surface 1, a second surface 2 and a third surface 3 with the surfaces having different thicknesses. The first surface 1 is connected with the third surface 3 and the second surface 2 is connect with the third surface 3.

Each of the first 1 and second 2 surfaces has an arc-shaped structure with a uniform thickness, while the third surface 3 has a dome-shaped structure with its middle part having an increased thickness than that of terminal parts. The thickness of the third surface 3 is larger than that of either the first or the second surfaces 1, 2. The intensity of the light reaching the first and second surfaces 1, 2 is less that that reaching the third surface 3, therefore the larger thickness of the third surface 3 enables the intensity of the light emitting from the third surface weak than that emitting from the first and second surfaces 1, 2. Meanwhile, due to the larger thickness in the middle part of the third surface 3, the intensity of the light emitting from the third surface 3 will be further homogenized. Further, the third surface 3 has an inner side parallel with the supports, such that the middle part of the surface 3 has a larger thickness than those of the terminal parts to achieve uniform intensity of emitting light from the third surface 3.

FIG. 2 illustrates a door for refrigerator using the illuminating tube as describe above. The door comprises a glass panel, a reflection plate and two lateral sides, and further includes a pair of the illuminating tubes 4 mounted on the two lateral sides of the door.

The distance between the illuminating tube 4 and the bottom side of the glass panel is 20 mm, and the distance between the tube 4 and the reflection plate is 70 mm. The glass panel has a thickness of 20 mm and a length of 650 mm such that the tube 4 can be mounted immediately to the top side of the glass panel 6. In this way, part of the light emitting toward the top side of the glass panel reflects toward partial area of the bottom side of the glass panel and majority part of the light reaches the reflection plate and reflects toward the top side of the glass panel and then toward a larger area of the bottom side of the glass panel.

The supports of the illuminating tube have a perpendicular plane having an angle 40 degree with respect to the horizontal plane. In this way, the light emitting from the third surface 3 covers the middle area of the reflection plate, while the majority part of the light emitting from the first and second surfaces 1,2 focuses on the lateral sides, terminal sides of the reflection plate and terminal parts of the top side of the glass panel. The angle is so designed that the light could distribute evenly on the glass panel and emit therefrom to achieve a desirable uniformity of intensity.

The invention has been described in reference to the examples set forth above. It should be noted that the examples given herein are for illustrative purpose only. Equivalent modifications or changes are possible and could not be exhaustively exemplified herein. Any improvements, changes, or substitutions made within the spirit and principle of the invention are within the scope of the appended claims.

1. An illuminating tube of a refrigerator comprising an illuminating surface, a mounting surface, and a support, the mounting surface being used to mount the illuminating tube onto a base and the support being disposed in a middle part inside the illuminating tube to support an illuminating chip, an electric circuit being disposed under the support, wherein the illuminating surface is consisted of a first, second and third surfaces having different thicknesses, wherein the first surface is connected with the third surface and the second surface is connected with the third surface.

2. The illuminating tube of a refrigerator of claim 1, wherein a pair of supports are symmetrically distributed in the inner sides of the tube with one of the supports connecting to the first surface and the other to the second surface.

3. The illuminating tube of a refrigerator of claim 2, wherein each of the first and second surfaces has an arc-shaped structure with a uniform thickness, while the third surface has a dome-shaped structure with its middle part having an increased thickness than that of terminal parts.

4. The illuminating tube of a refrigerator of claim 3, wherein the third surface has an inner side parallel with the supports.

5. A door for refrigerator using the illuminating tube of claim 1, comprising a glass panel, a reflection plate and two lateral sides, and further including a pair of the illuminating tubes mounted on the two lateral sides of the door.

6. The door for refrigerator of claim 5, wherein the distance between the illuminating tube and the bottom side of the glass panel ranges from 15 mm to 50 mm.

7. The door for refrigerator of claim 5, wherein the distance between the illuminating tube and the reflection plate ranges from 60 mm to 100 mm.

8. The door for refrigerator of claim 5, wherein the support has a perpendicular plane having an angle of between 20 degree and 70 degree with respect to the horizontal plane.
